(19) United States
(12) Patent Application Publication
(10) Pub. No.: US 2009/0324409 A1
(43) Pub. Date: Dec. 31, 2009

(54) ROTOR BLADE MONITORING

(76) Inventors: Mark Volanthen, Hampshire (GB); Roger Caesley, Hampshire (GB)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 12/465,233

(22) Filed: May 13, 2009

(30) Foreign Application Priority Data
May 13, 2008 (GB) 080651.4

(51) Int. Cl. B64C 27/46; G01L 1/22; G01L 1/24

(52) U.S. Cl. 416/61; 73/862.045; 73/800

(57) ABSTRACT

A method of monitoring mechanical characteristics of helicopter rotor blades 1 comprises mounting at least one strain sensor 2 to at least one rotor blade 1 and measuring the mechanical load on the rotor blade as indicated by the strain sensor 2.

### FIELD OF THE INVENTION

This invention relates to the monitoring of the rotation of helicopter rotor blades.

### BACKGROUND TO THE INVENTION

A helicopter is a complex collection of rotating assemblies that allow flight characteristics unavailable to fixed wing aircraft. Premature wear and failures in rotating helicopter components can be attributed to excess vibration levels. Reducing the vibration levels in the airframe to a minimum is absolutely essential in order to ensure the safety and longevity of the helicopter. “Rotor track and balance” is the process of smoothing vibrations in the airframe that are caused by the main rotor.

A helicopter main rotor is capable of producing vibrations in both the vertical and lateral planes. Vertical vibration is a result of unequal lift produced by the main rotor blades. This unequal lift is commonly the result of variances in the blade chord profile from one blade to the next or improper adjustment of pitch change links and trim tabs.

Lateral vibration is the result of an unequal distribution of mass in the main rotor “disk.” This unequal distribution can be a result of the manufacturing process, which allows differences in the weights of the blade or other component. Poor assembly techniques, improper alignment of a main rotor trunion, erosion, and a host of other possibilities can also contribute to lateral vibration. Lateral vibration may also be felt as a result of an aircraft that is out of vertical balance (or “track”), as a result of the airframe rolling with the mass effect caused by the unequal vertical lift component.

The term “rotor track and balance” can be misleading, in that “track” or “tracking” refers to adjusting the blade tip paths to make them fly in the same rotational plane. This does not always result in the smoothest ride, as some airframe and blade combinations will provide a smoother ride with a “track split” and the desired end result of the track and balance process should be the smoothest possible ride.

Balancing is performed in the primary rotational frequency of the main rotor. There are other main rotor vibrations present, such as the blade pass frequency of the main rotor. This is referred to as the “n-per-rev” (n=number of blades) frequency of the main rotor. If the mechanical condition of the helicopter is suspect, these vibrations can be quite noticeable once the main rotor 1-per-rev vibrations are reduced.

An early method employed by helicopter manufacturers and maintenance personnel to accomplish “rotor track and balance” was limited to the use of static balance equipment and tracking flags. A static balance device utilizes a “bubble” type level and balance arbour assembly suspended from a fixture to adjust the main rotor span-wise and chord-wise mass distribution. A tracking flag is a long lightweight pole held vertically, with two horizontal arms extending from it. Multiple strands of tape are attached between the horizontal arms, making a vertical ribbon-like connection from one to the other. The individual main rotor blade tips are coated with different coloured grease pencil or chalk. With the helicopter running on the ground, the flag is moved in toward the rotor disk. As the individually coloured blade tips make contact with the tape, each leaves a mark corresponding to its assigned colour. If the marks are vertically separated, a pitch change adjustment is needed to move the blades tips closer together. If the marks overlap one another, no adjustment is needed. This method has the disadvantages that it is dangerous, it is restricted to the ground only and therefore does not allow for track measurements in flight. Furthermore, the use of static rotor balancing devices is not applicable to some aircraft.

A further method of tracking the path of blade tips is to attach tip targets to the main rotor blades and visually “freeze” their flight path using a stroboscopic light source. This measurement can be performed for all flight speeds of interest, and remains in use. More advanced optical methods of acquiring track data include laser distance measurement using a laser mounted on the nose of the fuselage, which allows the user to collect track data without having to attach tip targets to the blade tips or visually interpret the position of the main rotor blades at a distance.

It is known to mount vibration sensors to specific locations on the airframe in order to measure and record vibration amplitudes in both the vertical and lateral planes. The amplitude measurements combined with the phase angle (or clock angle) of the vibration, allows a technician to manually plot corrections on a paper polar chart. Each polar chart is for a specific model of airframe.

All the known systems measure the rotor track at a single position and align the rotor blades to all pass through the same track at that single position. Yet it is known that smoothest running may be obtained from a split track where all the blades do not pass through the same point. The present invention, at least in its preferred embodiments, seeks to improve upon known systems.

### SUMMARY OF THE INVENTION

Accordingly, this invention provides a method of monitoring mechanical characteristics of helicopter rotor blades. The method comprises mounting at least one strain sensor to at least one rotor blade and measuring the mechanical load on the rotor blade as indicated by the strain sensor.

The rotor blade load measurements may be used for rotor track and balance. The same load measurements may be used for health monitoring of the rotor blades and the lead lag dampers that are used to reduce in-plane vibration of the blades.

This invention provides a system and method to track and balance a helicopter rotor. Rather than measuring rotor blade tip deflection, the loads in each rotor blade can be directly measured and compared to each other. The blades may be continuously compared at all positions as they rotate rather than just at a single position as in the prior art. For example, the system may be used to detect the onset of retreating blade stall. In addition, the system may be used to measure when safe loads have been exceeded. For example when the rotor exceeds its design rotation speed, the structure experiences excessive loads. According to the prior art, the rotor head must be stripped down to inspect the bearings. A load sensor according to the invention could avoid the need for such inspection.

With the method of the invention, the condition of the rotor blades can be monitored continuously at any position in the disc of the rotating blades. Thus, a helicopter may be provided with an appropriate control system and actuators to continuously optimise the positioning of the rotor blades in real time.

The strain sensor(s) may be an optical fibre strain sensor. The optical fibre strain sensor may comprise at least one fibre Bragg grating.

The strain sensor may be embedded in the rotor blade. The strain sensor may be located under the erosion strip of the rotor blade.

The method according to the invention may be applied to main rotors and/or tail rotors.

A plurality of strain sensors may be mounted to the rotor blade, with the strain sensors distributed about a longitudinal axis of the rotor blade, whereby mechanical loads about at least one axis orthogonal to the longitudinal axis can be measured. The strain sensors may be distributed about a longitudinal axis of the rotor blade, whereby mechanical loads in at least two orthogonal directions can be measured.

The strain sensors may be arranged to measure strain in a direction parallel to the longitudinal axis. Alternatively, the strain sensors may be arranged to measure strain in a direction at an acute angle to the longitudinal axis, whereby torque about the longitudinal axis can be measured.

Both axial loads, torsion loads and bending loads due to lift and drag may be measured. Axial loads are mainly attributable to centrifugal loads that depend on the rotor speed, rotor blade mass and location of the rotor blade centre of gravity. Axial loads can thus be used to balance the rotor using trimming weights.

Lift, drag and torsion loads of each rotor blade can be compared to the other blades and the pitch links or trip tabs can be adjusted to ensure all blades are operating in as identical manner as possible. By continuously monitoring during the entire blade sweep, the optimum configuration for each blade can be obtained for minimising vibration at any time and not just when the blade passes the nose of the aircraft. The lift and drag forces do not necessarily require resolving into in-plane and out-of-plane loads (especially since the blade pitch angle may not be measured) and lift and drag can be directly compared between blades at the same point in the sweep.

Lift, drag and axial load are measured using optical fibre strain sensors mechanically coupled to the rotor blades, preferably near the root of each rotor blade. Ideally there are four axial strain sensors equally spaced around the root to determine axial load, lift and drag. Further sensors oriented at an angle between 0 and 90 degree to the axis of the blade (preferably 45 degrees) can be used to measure torque.

A number of measurements along the blade enables the lift, drag and twist profile of the blade along its length to be measured and compared to other blades to balance not just the loads into the rotor head but actually the distribution of aerodynamic forces along the blade.

The blades are not rigidly coupled to the rotor head but can be considered to be coupled by a flexible (almost pinned) joint. The blades can oscillate within the plane of rotation. This motion is potentially damaging and is reduced or eliminated using lead-lag dampers located at the blade root. Monitoring of edgewise vibrations can provide condition monitoring information about the health of the lead lag dampers either by comparing blades or comparing a blade with a historical measurement of the blade.

By measuring lift and drag loads and comparing with other blades or histories, it is possible to identify a damaged blade, for example a blade with an eroded leading edge.

The invention extends to a helicopter rotor blade comprising at least one strain sensor and adapted for use in the above method, as well. as a helicopter rotor comprising a plurality of such rotor blades.

The invention also extends to a system for monitoring mechanical characteristics of helicopter rotor blades comprising a plurality of optical fibre strain sensors and an optical signal processing device adapted to implement the method.

In one embodiment, the optical (or other suitable) signal processing device may be mounted in the rotor of the helicopter. In such an arrangement, an optical connection between the signal processing device in the rotor and the optical fibre strain sensors in the rotor blade(s) may be made by means of an optical slip ring or similar optical interface. Desirably, the mutually rotating parts of the optical interface are spaced so that there is no mechanical contact (and wear) between them.

The strain sensors may be selected to have a range of strain measurement that corresponds to the range of strains reached when the rotor blades are rotating in normal use of the helicopter and the rotor blades are subjected to centrifugal forces due to the rotation. This provides extended range for the sensors. Thus, the (optical fibre) strain sensor(s) may be selected to be sensitive only to strain values above the range of strain values experienced by the static rotor blade. Thus, the wavelength of Bragg fibre gratings may be written appropriately.

### BRIEF DESCRIPTION OF THE DRAWINGS

Embodiments of the invention will now be described by way of example only and with reference to the accompanying drawings, in which:

FIG. 1 is a schematic view of a helicopter rotor blade provided with optical fibre strain sensors according to one embodiment of the invention; and

FIG. 2 is a schematic view of a helicopter rotor blade provided with optical fibre strain sensors according to another embodiment of the invention.

### DETAILED DESCRIPTION OF AN EMBODIMENT

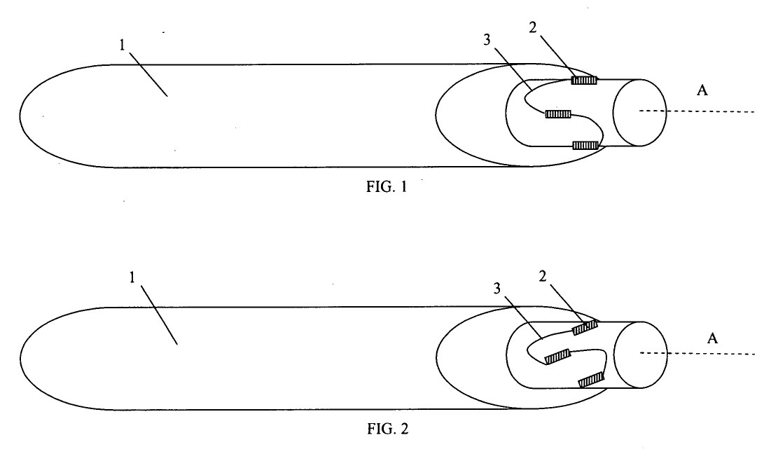

FIG. 1 is a schematic view of a helicopter rotor blade 1 provided with optical fibre strain sensors 2 according to one embodiment of the invention. The strain sensors 2 are provided as fibre Bragg grating (FBG) sensors in an optical fibre 3 in known manner. Suitable optical fibre strain sensor systems are described for example in our European Patent 02258640.8. The strain sensors 2 are mounted to the periphery of the base of the blade 1 and are arranged to measure strain in directions parallel to the longitudinal axis A of the blade 1. In this embodiment, four strain sensors 2 are provided and are equally distributed about the axis. By resolving the strain measurements from pairs of sensors 2, the mechanical load on the rotor blade 1 in the longitudinal axial direction, and about two orthogonal axes can be determined. The optical fibre strain sensors 2 are sufficiently responsive that the measured load signals represent the vibration of the rotor blade 1. Because the strain sensors 2 are mounted to the rotor blade and not just to the airframe, vibration measurements can be made during operation of the helicopter, including in flight, and at any point in the rotation of the rotor relative to the airframe.

FIG. 2 is a schematic view of a helicopter rotor blade 1 provided with optical fibre strain sensors according to another embodiment of the invention. In this embodiment, the strain sensors 2 are provided at an acute angle (45 degrees in this case) to the longitudinal axis A of the rotor blade 1. In this way, the strain sensors 2 are able to measure mechanical loads (torques) about the longitudinal axis A of the rotor blade. A combination of the sensor arrangements of the embodiments of FIGS. 1 and 2 may also be used if required. Indeed, optical fibre strain sensors may be provided along the rotor blade 1.

In summary, a method of monitoring mechanical characteristics of helicopter rotor blades 1 comprises mounting at least one strain sensor 2 to at least one rotor blade 1 and measuring the mechanical load on the rotor blade as indicated by the strain sensor 2.

Embodiments of the invention provide rotor balancing (reducing mass eccentricity) using axial load data for each blade rather than vibration measurement of the whole rotor. The invention is advantageous because it allows minimising vibrations by measuring loads, not tip deflection, including measuring at a large number of positions during the blade sweep not just at a single position. This enables determining an overall optimum set up for the blade rather than a set up based on a single position in the blade sweep. It is also possible to compare loads at several positions along the blade to not just balance the loads going into the rotor head (via sensors at the root) but to use additional sensors along the blade to identify the distribution of lift along the blade. With the invention it is possible to carry out condition monitoring of the blades by comparing lift/drag measurements, as well as condition monitoring of the lead-lag dampers using edgewise vibration measurements. Measurement according to the invention can be performed in flight or in a whirl tower where blades are tested and adjusted in the factory.

1. A method of monitoring mechanical characteristics of helicopter rotor blades, the method comprising:
mounting at least one strain sensor to at least one rotor blade; and
measuring the mechanical load on the rotor blade as indicated by the strain sensor.

2. A method as claimed in claim 1, wherein the strain sensor(s) is an optical fibre strain sensor.

3. A method as claimed in claim 2, wherein the optical fibre strain sensor comprises at least one fibre Bragg grating.

4. A method as claimed in claim 1, wherein the strain sensor is embedded in the rotor blade.

5. A method as claimed in claim 1 wherein a plurality of strain sensors are mounted to the rotor blade, with the strain sensors distributed about a longitudinal axis of the rotor blade, whereby mechanical loads about at least one axis orthogonal to the longitudinal axis can be measured.

6. A method as claimed in claim 5, wherein the strain sensors are distributed about a longitudinal axis of the rotor blade, whereby mechanical loads in at least two orthogonal directions can be measured.

7. A method as claimed in claim 5, wherein the strain sensors are arranged to measure strain in a direction parallel to the longitudinal axis.

8. A method as claimed in claim 5, wherein the strain sensors are arranged to measure strain in a direction at an acute angle to the longitudinal axis, whereby torque about the longitudinal axis can be measured.

9. A helicopter rotor blade comprising at least one strain sensor and adapted for use in the method of claim 1.

10. A helicopter rotor comprising a plurality of rotor blades as claimed in claim 9.

11. A system for monitoring mechanical characteristics of helicopter rotor blades comprising a plurality of optical fibre strain sensors and an optical signal processing device adapted to implement the method of claim 1.
